(19) United States
(12) Patent Application Publication
(10) Pub. No.: US 2006/0051067 A1
(43) Pub. Date: Mar. 9, 2006

(54) Method for editing a video data stream

(75) Inventors: Pin-Huang Hsin, Taipei (TW); Ching-Ho Huang, Taipei (TW)

Correspondence Address: BIRCH STEWART KOLASCH & BIRCH, PO BOX 747, FALLS CHURCH, VA, 22040-0747, US

(73) Assignee: Lite-On It Corporation, Taipei City (TW)

(21) Appl. No.: 11/212,871

(22) Filed: Aug. 29, 2005

(30) Foreign Application Priority Data
Aug. 30, 2004 (TW) 93125998

(51) Int. Cl. H04N 5/76

(52) U.S. Cl. 386/111; 386/112

(57) ABSTRACT

A method for editing a video data stream is suited for converting an analog AV signal into a MPEG file in a recordable player. The method includes the steps of: converting the analog AV signal into a plurality of continuous digital frames; inserting time information onto the digital frames; and encoding the digital frames with the time information into the MPEG file and recording the MPEG file onto an optical disc. In this way, when the recorded disc is played by different optical disk players, the time information is always shown on a screen at the same position.

This application claims the benefit of Taiwan application Serial No. 93125998, filed Aug. 30, 2004, the subject matter of which is incorporated herein by reference.

### BACKGROUND OF THE INVENTION

1. Field of the Invention

The invention relates in general to a method for editing a video data stream, and more particularly to a method for converting an analog AV signal into a MPEG (Moving Picture Experts Group) file and recording the MPEG file into an optical disc.

2. Description of the Related Art

The current recordable players available in the market may have the functions of reading, rewriting, and erasing data. So, the recordable player may be usually applied to the condition, which needs to preserve data, such as the captured film from the monitor in the building, the movie film, or the television program, for a long period of time. The recordable player mostly records the film into an optical disc or a hard disk in the file format of MPEG, and each file has creation time that is recorded in the head of the MPEG file in the data format.

Generally speaking, the conventional recordable player convents the received analog AV signal into a digital MPEG file. Thereafter, the MPEG file is recorded in the storage device, such as a hard disk or an optical disc. FIG. 1 is a flow chart showing a conventional method for recording an optical disc in a recordable player. The method includes the following steps.

Step 10 receives an analog AV signal.

Step 20 uses an A/D converter to convert the analog AV signal into a plurality of continuous digital frames.

Step 30 encodes the digital frames into a MPEG file.

Step 40 records the MPEG file into an optical disc.

In the case of recording a television program, the analog AV signal received through the antenna is inputted to the recordable player, and then an A/D converter samples the analog AV signal. Thereafter, a digital video data stream and a digital audio data stream are generated. The video data stream includes many continuous digital frames, each of which represents one picture. Typically, the frame rate of 20 to 30 frames per second makes the frames display on the screen in a very smooth manner.

However, because the unit of each frame in the digital video data stream is one pixel, the total data quantity of all the frames is quite large. In order to reduce the total data quantity, the digital video data stream and the digital audio data stream have to be encoded into a MPEG file so that the total data quantity may be compressed and reduced. Typically, the MPEG file is the MPEG 1 file, the MPEG 2 file, or the MPEG 4 file. After the MPEG file has been encoded, the MPEG file can be recorded into the optical disc and preserved permanently. Of course, the MPEG file may also be stored into the hard disk or other storage devices in the recordable player.

When the content of the optical disc is played, the optical disc may be placed into an arbitrary optical disk player, which can play the MPEG file in the optical disc. FIG. 2 is a flow chart showing a playing method for an optical disk player. The method includes the following steps.

Step 110 reads a MPEG file from an optical disc.

Step 120 decodes the MPEG file into a plurality of continuous digital decoded frames.

Step 130 converts the digital decoded frames into a television video signal and outputs the television video signal.

When the MPEG file is being played, the optical disk player has to firstly read the MPEG file and encode the MPEG file into a digital video signal and a digital audio signal. The digital video signal includes multiple continuous digital decoded frames. The graphic chip in the optical disk player receives the digital decoded frames, converts the frames into a television video signal, and transfers the television video signal to the television through AV terminals or S terminals. Then, the continuous digital decoded frames may be displayed on the screen. Similarly, the audio chip receives the digital audio signal and converts the digital audio signal into a television audio signal. Then, the television audio signal is transferred to the television through the AV terminals or the S terminals, and the speaker outputs the audio signal. Thus, the film contents recorded in the recordable player may be played on the screen of the television.

Furthermore, because the function of the optical disk player continuously advances, some optical disk players have the function of displaying the recording time of the film while playing the MPEG file, such that the user can obtain the recording time, such as the information of date, time instant, and the like, while he or she is watching the film. Such a kind of optical disk player mainly utilizes the creation time recorded in the head of the MPEG file to achieve the function of displaying the time when the film is recorded while the MPEG file is being played. FIG. 3 is a flow chart showing a playing method for an optical disk player with the function of displaying the recording time of the film. The method includes the following steps.

Step 210 reads a MPEG file from an optical disc.

Step 220 sets creation time in the head of the MPEG file as initial time.

Step 230 decodes the MPEG file into a plurality of continuous digital decoded frames.

Step 240 starts to convert the digital decoded frames into a television video signal while counting the time from the initial time and inserting the time information onto a television video signal.

Such a kind of optical disk player has to read the creation time in the head of the MPEG file as the initial time while playing the MPEG file, and the graphic chip has to start to count the time from the initial time and continuously insert the time information onto the television video signal while outputting the television video signal. So, when the digital decoded frames are being played, the time variation, which represents the recording time of the film, can be displayed on the screen.

However, not all of the optical disk players can support such a function. Instead, some fundamental or low-cost optical disk players cannot display the recording time of the film on the screen while playing the film. Furthermore, the optical disk players with this kind of function may display the time information at different positions on the screen and display the time information with different colors to confuse the user due to different settings of various brands.

### SUMMARY OF THE INVENTION

It is therefore an object of the invention to provide a method for editing a video data stream, such that the time information can be displayed on the screen at the same position while an optical disc, in which the edited MPEG file is stored, is played over different optical disk players.

The invention achieves the above-identified object by providing a method for editing a video data stream. The method includes the steps of: receiving an analog AV (Audio-Video) signal; converting the analog AV signal into a plurality of continuous digital frames; inserting time information onto the digital frames; encoding the digital frames with the inserted time information into a MPEG (Moving Picture Experts Group) file; and recording the MPEG file into a storage device.

The invention achieves the above-identified object by providing a method for editing a video data stream. The method includes the steps of: receiving an analog AV signal; converting the analog AV signal into a digital video data stream and a digital audio data stream, wherein the digital video data stream has a plurality of continuous digital frames; inserting time information onto the digital frames of the digital video data stream; encoding the digital video data stream and the digital audio data stream into a MPEG (Moving Picture Experts Group) file; and recording the MPEG file into a storage device.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a flow chart showing a conventional method for recording an optical disc in a recordable player.

FIG. 2 is a flow chart showing a playing method for an optical disk player.

FIG. 3 is a flow chart showing a playing method for an optical disk player with the function of displaying recording time of a film.

FIG. 4 is a flow chart showing a method for recording a video disc in the recordable player of the invention.

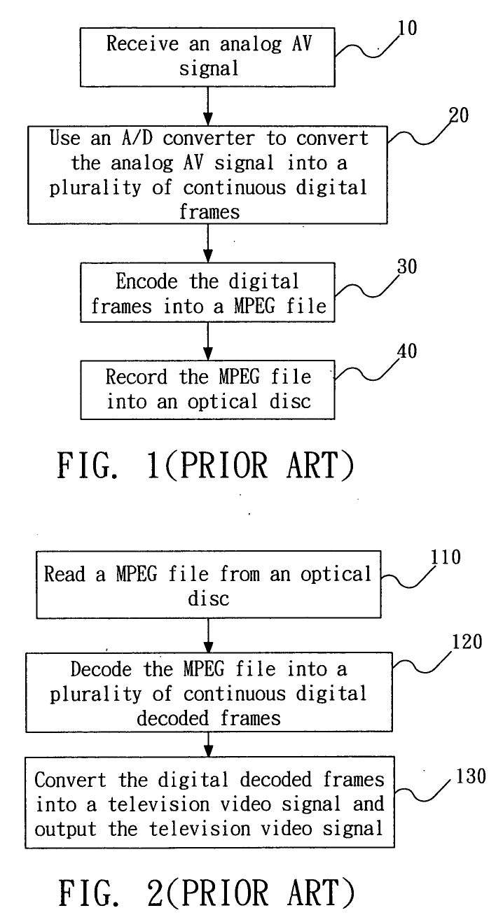

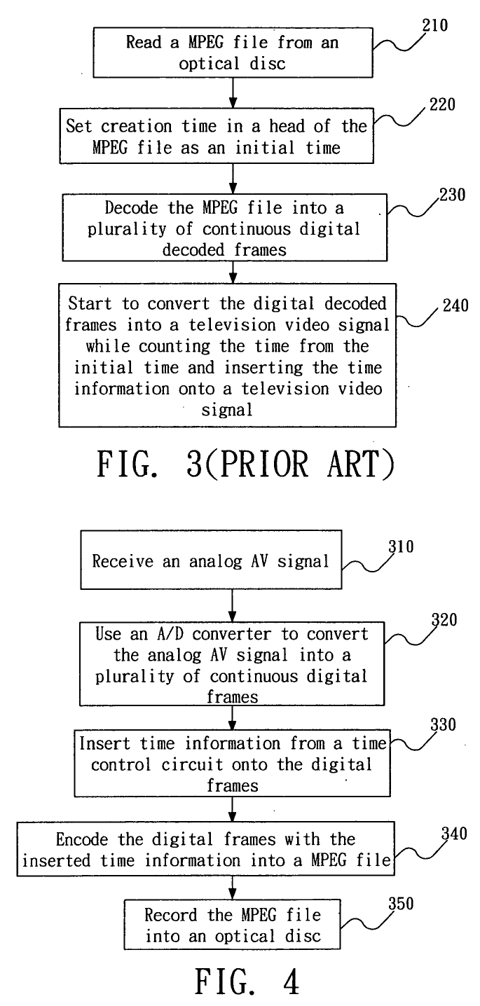

### DETAILED DESCRIPTION OF THE INVENTION

Generally speaking, all recordable players have a time control circuit or a perpetual calendar control chip for displaying the current date and time on the display, such as a LCD display, disposed on the operation panel of the recordable player. Thus, the invention utilizes the time control circuit of the recordable player to directly insert the time information onto the digital frames before the digital frames are encoded, and then encode the digital frames. FIG. 4 is a flow chart showing a method for recording a video disc in the recordable player of the invention. The method includes the following steps.

Step 310 receives an analog AV signal.

Step 320 uses an A/D converter to convert the analog AV signal into a plurality of continuous digital frames.

Step 330 inserts time information from a time control circuit onto the digital frames

Step 340 encodes the digital frames with the inserted time information into a MPEG file.

Step 350 records the MPEG file into an optical disc.

In the case of recording a television program, the analog AV signal received through the antenna is inputted to the recordable player, and then an AND converter samples the analog AV signal. Thereafter, a digital video data stream and a digital audio data stream are generated. The video data stream includes many continuous digital frames. However, because the unit of each sampled digital frame is one pixel, the invention directly inserts the time information onto each digital frame. That is, after each digital frame has been sampled by the A/D converter, the recordable player has to capture the time information from the time control circuit and convert the time information into the time pattern, which is directly pasted on the specific position, such as a lower left corner or a lower right corner, in the digital frame, such that the pattern of the time information is displayed at a specific position of each digital frame.

Next, all the digital frames with the inserted time information have to be encoded into a MPEG file such that the data quantity is compressed and reduced. Thus, the digital video data stream with the inserted time information and the digital audio data stream are encoded into a MPEG file, such as a MPEG 1 file, a MPEG 2 file, or a MPEG 4 file. Finally, the MPEG file may be recorded in the optical disc and preserved permanently. Of course, the MPEG file may also be stored in the hard disk or other storage devices of the recordable player.

The encoding operation cannot be performed before the time information is inserted on the digital frame in this invention. So, when the MPEG file produced using the method of editing the video data stream of the invention is played in the typical optical disk player, the optical disk player can display the recording time of the film at a specific position of the screen without the special function of displaying the recording time. That is, because the digital frames are encoded after the time information is directly inserted onto the digital frames, each of the digital decoded frames contains the time information at a specific position after the typical optical disk player has decoded the MPEG file according to the flow chart of FIG. 2. Consequently, when the television video signal generated by the optical disk player is transferred to the screen of the television, the time information for representing the recording time of the film, such as the recording date and time instant, may be displayed at the specific position of the screen.

The conventional optical disk player has to set the initial time according to the creation time in the head of the MPEG file and continuously insert the time information onto the television video signal, and not all of the optical disk players have the function of displaying the recording time of the film. Thus, when the MPEG file is recorded in the optical disc according to the invention method of editing a video data stream, the recording time of the film can be displayed regardless of the brands of the optical disk players.

In summary, when the optical disc, which is recorded according to the invention method of editing the optical disc, is being played, the displayed time information generated by various kinds of optical disk players will not be different from one another. In other words, when the optical disc is being played by different optical disk players, displayed positions and formats of the time information on the screen are always the same.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for editing a video data stream, comprising the steps of:
receiving an analog AV (Audio-Video) signal;
converting the analog AV signal into a plurality of continuous digital frames;
inserting time information onto the digital frames;
encoding the digital frames with the inserted time information into a MPEG (Moving Picture Experts Group) file; and
recording the MPEG file into a storage device.

2. The method according to claim 1, wherein the time information is provided by a time control circuit.

3. The method according to claim 1, wherein the MPEG file is a MPEG 1 file, a MPEG 2 file or a MPEG 4 file.

4. The method according to claim 1, wherein the storage device is a hard, disk or an optical disc.

5. A method for editing a video data stream, comprising the steps of:
receiving an analog AV (Audio-Video) signal;
converting the analog AV signal into a digital video data stream and a digital audio data stream, wherein the digital video data stream has a plurality of continuous digital frames;
inserting time information onto the digital frames of the digital video data stream;
encoding the digital video data stream and the digital audio data stream into a MPEG (Moving Picture Experts Group) file; and
recording the MPEG file into a storage device.

6. The method according to claim 5, wherein the time information is provided by a time control circuit.

7. The method according to claim 5, wherein the MPEG file is a MPEG 1 file, a MPEG 2 file or a MPEG 4 file.

8. The method according to claim 5, wherein the storage device is a hard disk or an optical disc.
